(19) United States
(12) Patent Application Publication
(10) Pub. No.: US 2026/0142863 A1
(43) Pub. Date: May 21, 2026

(54) TIME-DIVISION MULTIPLEXING (TDM) AND RESOURCE ALLOCATION

(71) Applicant: MaxLinear, Inc., Carlsbad, CA (US)

(72) Inventor: Curtis Ling, Carlsbad, CA (US)

(73) Assignee: MaxLinear, Inc., Carlsbad, CA (US)

(21) Appl. No.: 19/397,708

(22) Filed: Nov. 21, 2025

Related U.S. Application Data
(60) Provisional application No. 63/723,525, filed on Nov. 21, 2024.

(51) Int. Cl. H04L 27/26; H04L 5/00; H04L 43/087

(52) U.S. Cl. CPC H04L 27/2656; H04L 5/0048; H04L 43/087

(57) ABSTRACT

Technology for a device used for time division multiplexing is disclosed. The device may include a plurality of digital signal processors (DSPs). The device may include a plurality of analog crossbars operable to be connected to the plurality of DSPs. The plurality of analog crossbars may be operable to: receive, at one or more input ports of the plurality of analog crossbars, input data from the plurality of DSPs; and send, from an output port of the plurality of analog crossbars, time-division multiplexed (TDM) output data.

### RELATED APPLICATION

This application claims the benefit of U.S. Provisional Application No. 63/723,525, filed November 21, 2024, the disclosure of which is incorporated herein by reference in its entirety.

The examples discussed in the present disclosure are related to time-division multiplexing (TDM) and resource allocation.

### BACKGROUND

Unless otherwise indicated herein, the materials described herein are not prior art to the claims in the present application and are not admitted to be prior art by inclusion in this section.

Datacenters and AI clusters may use Ethernet switches that are packet switched. Using a packet switched Ethernet switch may result in delivery that is not reliable, is variable, and has high latency. Fabric switches may provide another possibility in datacenters and artificial intelligence (AI) clusters. Fabric switches, unlike Ethernet switches, may be equivalent to circuit-switched networks, rather than packet-switched networks.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

A device may include a plurality of digital signal processors (DSPs). The device may include a plurality of analog crossbars operable to be connected to the plurality of DSPs. The plurality of analog crossbars may be operable to: receive, at one or more input ports of the plurality of analog crossbars, input data from the plurality of DSPs; and send, from an output port of the plurality of analog crossbars, time-division multiplexed (TDM) output data.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates an example device including a plurality of digital signal processors (DSPs) and a plurality of analog crossbars using time division multiplexing.

FIG. 2 illustrates an example device including a plurality of digital signal processors (DSPs) and a plurality of analog crossbars using time division multiplexing with a common reference clock.

FIG. 3 illustrates an example timing diagram used for time division multiplexing.

FIG. 4 illustrates an example process flow of a device for time division multiplexing.

FIG. 5 illustrates an example communication system operable for time division multiplexing.

FIG. 6 illustrates a diagrammatic representation of a machine in the example form of a computing device within which a set of instructions, for causing the machine to perform any one or more of the methods discussed herein, may be executed.

FIG. 7A illustrates an example block diagram of a data center.

FIG. 7B illustrates an example switch device.

FIG. 7C illustrates an example switch device.

FIG. 7D illustrates an example switch device.

### DESCRIPTION

The systems and methods of the examples described below pertains to the field of high-speed network switches and physical media dependent (PMD) devices with crossbar-based architectures. Modern networks often experience fluctuating traffic patterns and congestion, which may be enhanced by dynamic and efficient allocation of crossbar resources. Traditional static or fixed-path routing techniques may lack the flexibility to respond to real-time network demands, often leading to inefficient bandwidth utilization and increased latency.

Time-Division Multiplexing (TDM) may provide a method for scheduling and sharing crossbar resources by dividing available bandwidth into discrete time slots allocated dynamically based on the demands of connected devices or data flows. The examples described below integrate TDM at the PMD and crossbar levels, advantageously leveraging

DSP functionality for synchronous and asynchronous scheduling, priority-based allocation, and real-time adjustments to traffic conditions.

Moreover, the examples described below provide efficient network protocols for controlling analog crossbars in networks switch fabrics. For example, some switch fabrics may assume a packet-switched architecture, rather than an analog electrical circuit switch (AECS) without packet inspection and buffering. Circuit switching does not allow for sharing connections.

Accordingly, the examples described below provide an AECS architecture for using time-division multiplexing (TDM) to share connections. In some examples, a switch controller (SC), a digital signal processor (DSP), and a crossbar integrated circuit (IC) may reconfigure connections periodically in a synchronized manner to implement TDM of a connection. By using TDM, an output port may be shared by multiple input ports. Synchronization may have an overhead cost. For example, a DSP may use a serializer/deserializer (SERDES) connection when interrupted. By optimizing bandwidth allocation and resource sharing across the system, an AECS may efficiently manage traffic without excessive latency. This optimization may be effectuated by one or more of reacquisition techniques, synchronization of multiple resources, or minimizing latency during TDM cycles.

Examples described herein will be explained with reference to the accompanying drawings.

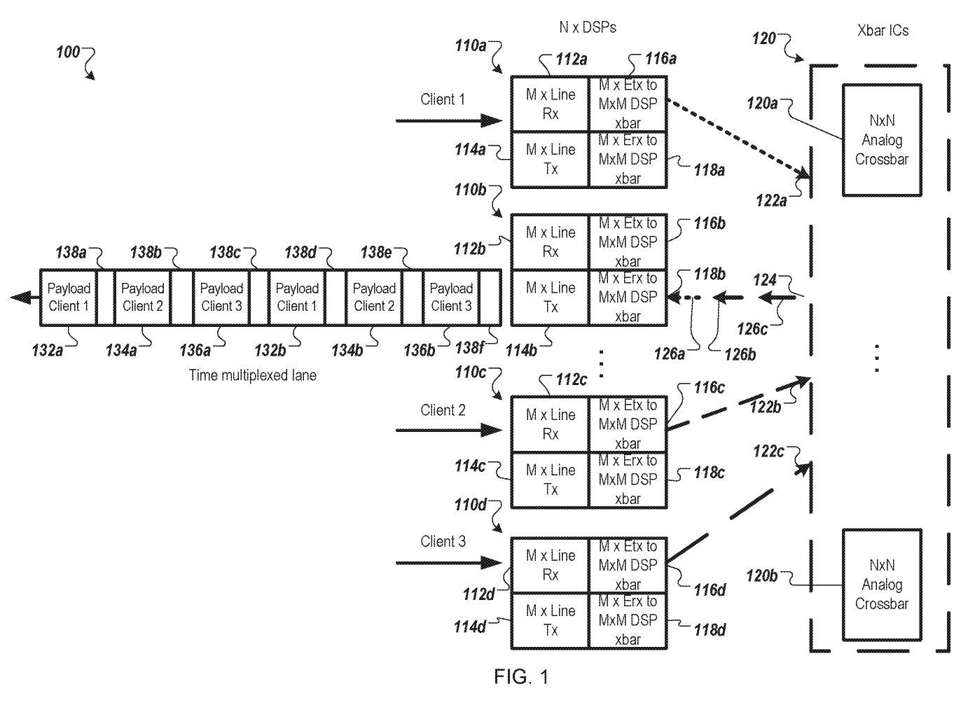

As illustrated in FIG. 1, time division multiplexing may be used in a device 100. The device 100 may include a plurality of digital signal processors (DSPs) 110a, 110b, 110c, 110d. Although four DSPs have been shown, any suitable number of DSPs may be used. The device 100 may include a plurality of analog crossbars 120a, 120b that may be connected to the plurality of DSPs 110a, 110b, 110c, 110d. Although two analog crossbars have been shown, any suitable number of analog crossbars may be used. In some examples, the analog crossbars 120a, 120b may be an optical circuit switch. The plurality of analog crossbars 120a, 120b may receive, at one or more input ports 122a, 122b, 122c of the plurality of analog crossbars 120a, 120b, input data from the plurality of DSPs 110a, 110b, 110c, 110d. Although three input ports have been shown, any suitable number of input ports may be used. The plurality of analog crossbars 120a, 120b may send, from an output port 124 of the plurality of analog crossbars 120a, 120b, time-division multiplexed (TDM) output data 126a, 126b, 126c. A single output port may be used to send the TDM output data. The TDM output data 126a, 126b, 126c may be based on input data from a plurality of input ports (e.g., 122a, 122b, 122c).

The TDM output data may be communicated using a time multiplexed lane. The time multiplexed lane may include payload client 1132a, payload client 2134a, payload client 3136a, payload client 1132b, payload client 2134b, and payload client 3136b. A reacquisition block 138a, 138b, 138c, 138d, 138e, 138f may provide time between each of the payloads.

The plurality of DSPs 110a, 110b, 110c, 110d may have various functionality. For example, on the line side, DSP 110a may have an M x Line Rx 112a and an M x Line Tx 114a. DSP 110b may have an M x Line Rx 112b and an M x Line Tx 114b. DSP 110c may have an M x Line Rx 112c and an M x Line Tx 114c. DSP 110d may have an M x Line Rx 112d and an M x Line Tx 114d. The plurality of DSPs may be in communication with different clients. For example, client 1 may be in communication with DSP 110a, client 2 may be in communication with DSP 110c, and client 3 may be in communication with DSP 110d.

For example, on the switch-side, DSP 110a may have an M x Etx to MxM DSP crossbar 116a and an M x Erx to MxM DSP crossbar 118a. DSP 110b may have an M x Etx to MxM DSP crossbar 116b and an M x Erx to MxM DSP crossbar 118b. DSP 110c may have an M x Etx to MxM DSP crossbar 116c and an M x Erx to MxM DSP crossbar 118c. DSP 110d may have an M x Etx to MxM DSP crossbar 116d and an M x Erx to MxM DSP crossbar 118d.

The plurality of analog crossbars 120a, 120b may be incorporated in a crossbar integrated circuit (IC) 120. The plurality of analog crossbars 120a, 120b may have multiple inputs and multiple outputs. In some examples, the analog crossbars 120a, 120b may be an optical circuit switch.

As illustrated, TDM may allow the plurality of DSPs 110a, 110b, 110c, 110d to share connection bandwidth using cyclical time division allocation to improve efficiency. That is, TDM may be implemented in crossbars to facilitate sharing of connection bandwidth. TDM may be implemented by using layer 2 capabilities to determine a schedule for communication resource allocation.

In some examples, duty cycling and/or fractional ports may be used. For example, port 1 may share bandwidth with port 3 so that 50% of the bandwidth may be used by port 1 and 50% of the bandwidth may be used by port 3.

TDM may be used in a variety of ways. In a crossbar, a time series of switch configurations may be implemented in cooperation with or synchronously with other crossbars. Allowing the crossbars to manage TDM settings semi-autonomously and programmatically may facilitate faster reconfiguration with low overhead.

There may be many variants of crossbar resource management and optimized utilization. For example, time division duplexing may be pipelined. Pipelining may be facilitated by using virtual input queues or queues in the DSP.

The TDM output data 126a, 126b, 126c may be allocated using periodic resource allocation. Efficient communication between the plurality of DSPs 110a, 110b, 110c, 110d may be effectuated by using medium access protocols. A synchronous resource allocation cycle may be similar to a medium access protocol (MAP) cycle between the DSP and the client or across the plurality of DSPs 110a, 110b, 110c, 110d. Time synchronization may be obtained using IEEE 1588 protocols and may operate with synchronous MAP cycles. Thus, a time base may be established across the plurality of DSPs 110a, 110b, 110c, 110d.

The plurality of DSPs 110a, 110b, 110c, 110d may synchronize timing between crossbar switches of the plurality of DSPs 110a, 110b, 110c, 110d to reduce one or more of jitter or symbol drift. As mentioned, a common time base may be established using IEEE 1588 protocols. Synchronizing using IEEE 1588 may lock the plurality of DSPs 110a, 110b, 110c, 110d to a common time basis that is precise to a nanosecond level. IEEE 1588 may be used for synchronization without establishing a separate clock domain.

When IEEE 1588 is not used, then a common clock signal may be used. A common clock signal may be implemented using flow control. Flow control includes packets that are received by the plurality of DSPs 110a, 110b, 110c, 110d in which the packets may be sped up or the packets may be slowed down.

The plurality of DSPs 110a, 110b, 110c, 110d may be synchronized using a microcontroller unit (MCU). In some examples, the plurality of DSPs 110a, 110b, 110c, 110d may each include a processor that may allow the plurality of DSPs 110a, 110b, 110c, 110d to communicate with each other using an out-of-band serial peripheral interface (SPI).

The MCU may be connected to all, or some, of the analog crossbars 120a, 120b. The MCU may facilitate switching using higher layer signaling. This switching may be facilitated using e.g., SPI to communicate between the MCU and the analog crossbars 120a, 120b.

An example of synchronization may include various ports communicating with each other. For example, port 1, lane 1 may attempt to communicate with port 8, lane 8 while port 2, lane 2 may also attempt to communicate with port 8, lane 8. The switch controller may switch back and forth between the different input sources. The switching between port 1, lane 1 and port 2, lane 2 may be adequately fast to facilitate time division multiplexing.

The plurality of DSPs 110a, 110b, 110c, 110d may have different baud. Therefore, a clock recovery unit may be used. When the plurality of DSPs 110a, 110b, 110c, 110d may be disconnected, then reacquisition may be implemented. When the channel is static, then the equalizer (e.g., feed forward equalizer (FFE), continuous time linear equalizer (CTLE)) may be unchanged which may reduce the amount of time used to perform reacquisition.

The reacquisition time sets the overhead when performing time division multiplexing of the plurality of DSPs 110a, 110b, 110c, 110d and the plurality of analog crossbars 120a, 120b. Acquisition can occur in less than 100 symbols (i.e., about 2 nanoseconds (ns)). In this case, a 40 ns timeslot may incur an overhead of about 5%. A known preamble may also be used for reacquisition as well as additional training. This reacquisition time may be adequately fast to be used with non-fabric switch applications. In addition, make before break (MBB) may be used to further reduce reacquisition overhead.

The plurality of DSPs may reacquire one or more of an equalization setting or a calibration setting during a TDM transition. Additional timing overhead may be allocated for the plurality of DSPs 110a, 110b, 110c, 110d to reacquire when a crossbar connection has been changed. Sufficient time between time duplexing may be allocated for reacquisition. Reacquisition is used because the plurality of DSPs 110a, 110b, 110c, 110d may not be synchronized. Reacquisition may be enhanced by using look up tables (LUTs) for e.g., FFE, clock recovery unit (CRU), PI settings, or the like. The plurality of DSPs may store a previous configuration of one or more of an equalization setting or a calibration setting in a look-up table (LUT) for faster reacquisition. Reacquisition may be enhanced by storing equalization, channel models, DSP settings for one or more connections. The analog electrical circuit switch (AECS) and/or the plurality of DSPs 110a, 110b, 110c, 110d may maintain the LUT for e.g., the equalizer and the CRU. The LUT may be used to speed up acquisition and to facilitate tracking when switching from one connection to another.

The plurality of DSPs may use make before break to minimize reacquisition overhead during connection sharing. The plurality of DSPs may use make before break to facilitate time slot transitions.

The plurality of DSPs may queue data during time slot transitions. That is, input and output buffering may be used to enhance the efficiency of TDM by queuing data during time slot transitions. Queueing may be used specifically for network resource sharing as well as providing backpressure/flow control (L2 function) e.g. to allow sharing of a given output port's bandwidth through TDM. Adjustable queue depth may be based on latency of traffic. Input queuing may be synchronized with switch reconfiguration and output queuing.

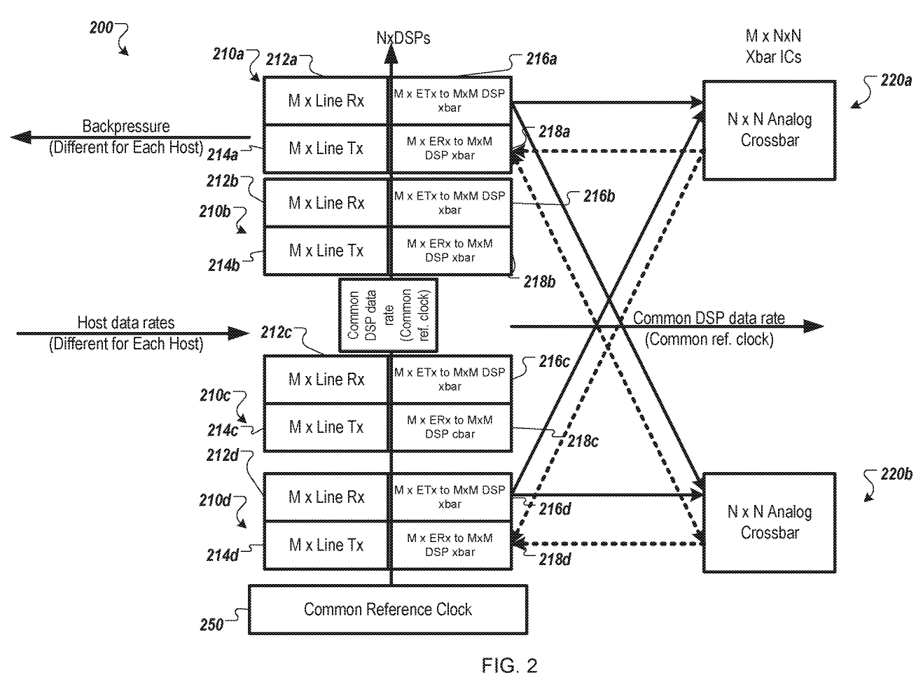

As illustrated in FIG. 2, a device 200 may include a plurality of DSPs 210a, 210b, 210c, 210d that may each include various functionality. For example, DSP 210a may include M x Line Rx 212a, M x Line Tx 214a, M x ETx to MxM DSP crossbar 216a, and M x ERx to MxM DSP crossbar 218a. For example, DSP 210b may include M x Line Rx 212b, M x Line Tx 214b, M x ETx to MxM DSP crossbar 216b, and M x ERx to MxM DSP crossbar 218b. For example, DSP 210c may include M x Line Rx 212c, M x Line Tx 214c, M x ETx to MxM DSP crossbar 216c, and M x ERx to MxM DSP crossbar 218c. For example, DSP 210d may include M x Line Rx 212d, M x Line Tx 214d, M x ETx to MxM DSP crossbar 216d, and M x ERx to MxM DSP crossbar 218d. The device may also include a plurality of analog crossbars 220a, 220b.

A plurality of DSPs 210a, 210b, 210c, 210d may include buffering specifically used for the sharing of a medium or resource e.g. in a TDM manner. Buffering may include a first in first out (FIFO) memory. Different traffic priorities may be accommodated by dynamically configuring buffer policy. A resource allocation policy may include allocating buffering and signaling backpressure to requestors in accordance with that policy. Buffering may be implemented at the input and output of the device 200. The buffer depth may be based on a latency target or policy. TDM slots may be reserved for provisional bandwidth granting.

Buffers may be implemented at both input and output DSPs. Buffers may be used to share the switch resource and for in-band management. Each lane may be independently managed. For example, a given output lane may be time duplexed across one or more input lanes. A given input lane may time duplex its bandwidth across one or more output lanes.

A DSP may receive or transmit M lanes of traffic. A DSP may Tx/Rx M Line in-band lanes, and a DSP may Tx/Rx M lanes on the switch in-band lanes. Each switch in-band lane may connect via crossbars to another DSP’s switch in-band (IB) lane. Each lane of line traffic may be coming from a different server. In addition, fractions of traffic may be combined for a plurality of line in-band lanes to or from a plurality of switch in-band lanes. L2 functionality may be used to implement this functionality to allow for efficient and simple sharing of switch in-band lanes.

The plurality of DSPs 210a, 210b, 210c, 210d may use one or more of flow control or internet protocol (IP) termination to enhance TDM efficiency. For example, backpressure (which may be different for each host) may be used. In addition, the host data rates may be different for each host. Backpressure may be used to avoid over-flow and/or under-flow. For example, backpressure may signal using a protocol to a sender (e.g., a host) that the rate is too high or too low and that the sender (e.g., a host) may adjust the rate.

The DSP and the switch controller may maintain an independent data rate (i.e. symbol rate or baud). Instead of transferring clock from input (Client side) to output (switch side), maintain independent baud within the switch system (shared across the DSPs). Backpressure may be used to adjust the flow of ingress data from the client into the DSP. Within the device 200, all DSPs may use identical data rates which may reference a common clock. Each multiplex path may retain and equalizer and clock recovery state.

In an example of flow control, port 1, lane 1 and port 2, lane 2 may be in communication with port 8, lane 8. When port 1, lane 1 is communicating with port 8, lane 8, then port 2, lane 2 may be buffering. Once port 2, lane 2 has its turn, port 2, lane 2 may communicate with port 8, lane 8 while port 1, lane 1 is buffering. Buffering may occur both at the input and at the output. Buffering at the output provides the advantage that port may be fully utilized at the port. Therefore, there are various ways of buffering including input queueing, output queuing, and virtual output queuing. The memory used for buffering may be distributed across the plurality of DSPs. Because of the distribution of memory, the die size does not increase and scaling limits are not exceeded.

The plurality of DSPs may synchronize timing between the plurality of DSPs using a common clock source. The common clock source may be used to synchronize the plurality of DSPs 210a, 210b, 210c, 210d to the common clock source. The common clock may facilitate fast acquisition of timing (frequency, phase) after a switch has been reconfigured. The common clock may also reduce jitter and improve link performance. The device 200 may use this common clock, or use independent clocks at each DSP. The common clock may also be established and maintained through 1588 or similar protocol ("semi-synchronously"), in which DSPs have slightly different baud and thus may result in using CRU and having longer reacquisition.

The common reference clock 250 may be used to synchronize the plurality of DSPs 210a, 210b, 210c, 210d to prevent drifting. By using the common reference clock 250, symbol timing may be substantially the same even when the internal symbol timing differs from the external symbol timing. Because of the different rates coming in for each of the DSPs, each DSP may have a different clock offset. The common clock may be used to synchronize the different rates.

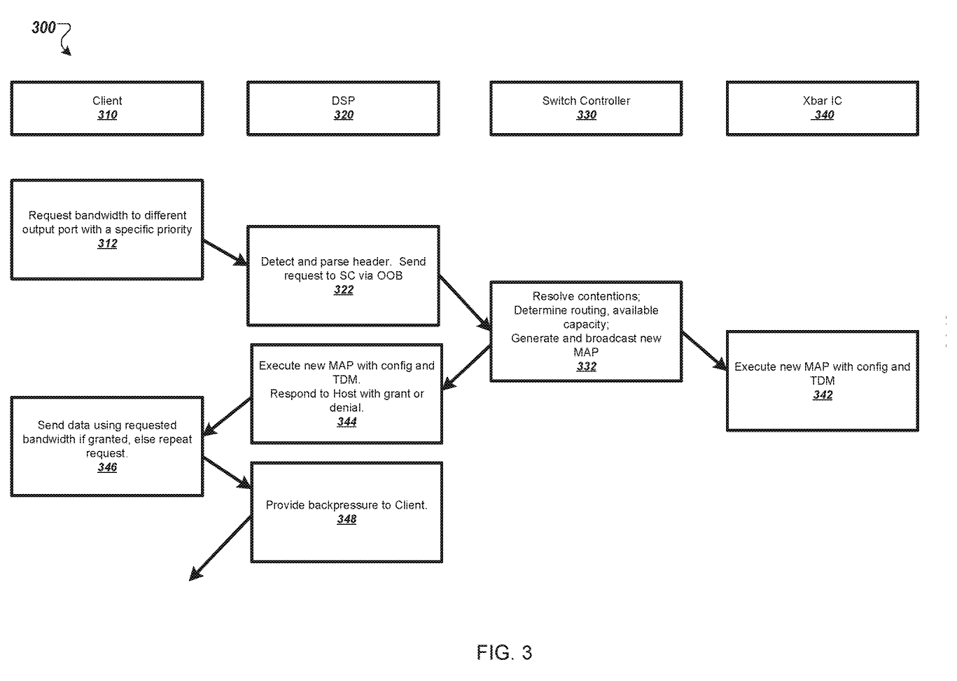

As illustrated in FIG. 3, a timing diagram 300 showing communication between a client 310, a DSP 320, a switch controller 330, and a crossbar IC 340 (i.e., including a plurality of analog crossbars) is illustrated. The client 310 may communicate with the DSP 320 by requesting bandwidth to a different output port with a specific priority, as in block 312. The DSP 320 may detect and parse the header and send a request to the switch controller 330 via out-of-band communication, as in block 322. The switch controller 330 may resolve contentions, determine routing and available capacity, and generate and broadcast new MAP, as in block 332. The crossbar IC 340 may execute the new MAP with configuration and TDM, as in block 342. The DSP 320 may execute new MAP with configuration and TDM, and respond to the host with grant or denial, as in block 344. The client 310 may send data using requested bandwidth if granted, or else repeat the request, as in block 346. The DSP 320 may provide backpressure to the client 310, as in block 348.

The operations provided in FIG. 3 may be performed globally (e.g., on a network node) and may use e.g., segment routing over IPv6 dataplane (SRV6) technology and/or software-defined networking (SDN). An SDN controller may request bandwidth and receive allocation. Using SDN may provide a global view of congestion so that routing may be performed more efficiently.

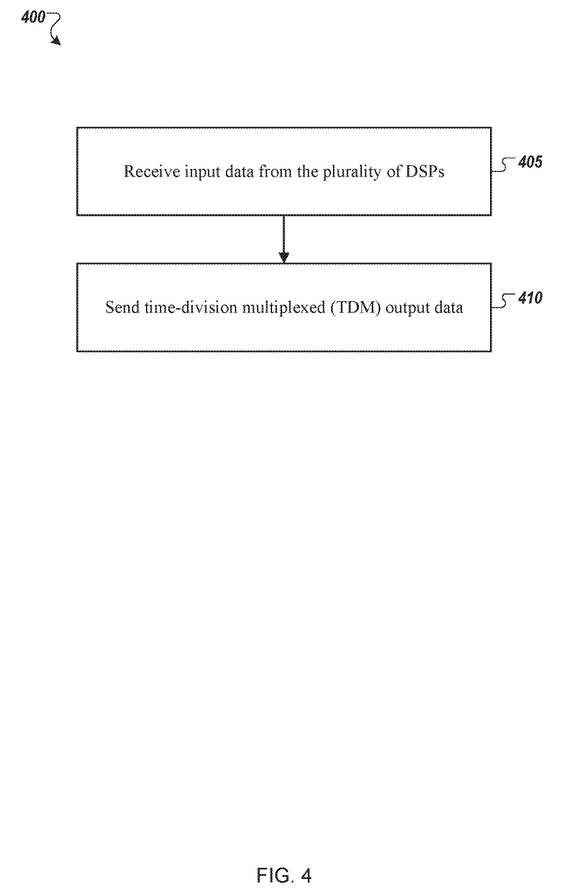

FIG. 4 illustrates a process flow of an example method 400 of time division multiplexing, in accordance with at least one example described in the present disclosure. The method 400 may be arranged in accordance with at least one example described in the present disclosure.

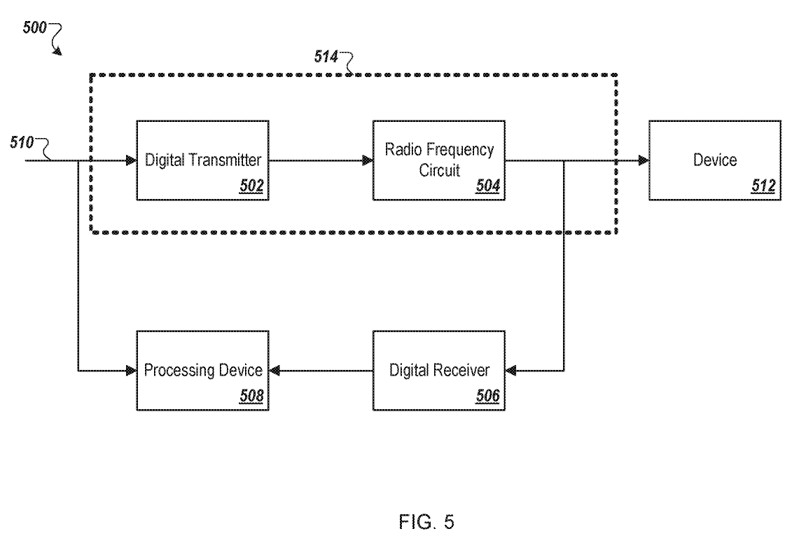

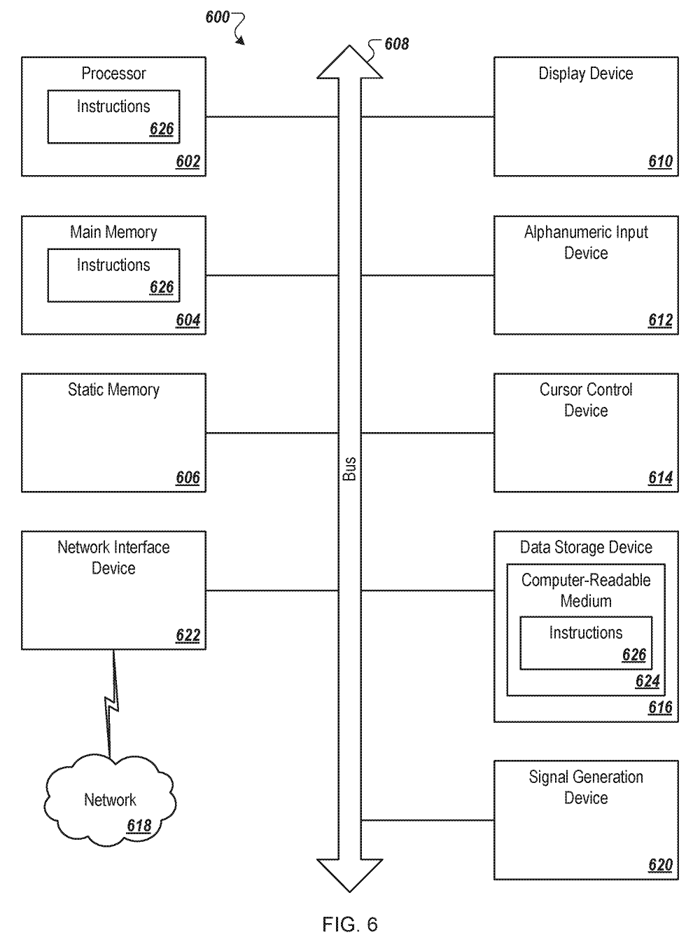

The method 400 may be performed by processing logic that may include hardware (circuitry, dedicated logic, etc.), software (such as is run on a computer system or a dedicated machine), or a combination of both, which processing logic may be included in the processing device 602 of FIG. 6, the communication system 500 of FIG. 5, or another device, combination of devices, or systems.

The method 400 may begin at block 405 where the processing logic may receive, at one or more input ports of the plurality of analog crossbars, input data from the plurality of DSPs.

At block 410, the processing logic may send, from an output port of the plurality of analog crossbars, time-division multiplexed (TDM) output data.

In some examples, the method may be implemented in a network architecture incorporating an analog electrical circuit switch (AECS). The method may include one or more of: receiving, at one or more input ports of a plurality of analog crossbars, input data from a plurality of digital signal processors (DSPs); determining time slots dynamically to the plurality of DSPs based on one or more of real-time bandwidth, traffic priority levels, or network conditions; configuring, at a switch controller, the plurality of analog crossbars to facilitate sharing of output ports by the plurality of DSPs during allocated time slots; synchronizing the time slots across the plurality of DSPs and analog crossbars using one or more of a common time base or synchronization protocol; transmitting, from one or more output ports of the plurality of analog crossbars, time-division multiplexed output data comprising data from multiple input ports; and maintaining synchronization of the plurality of DSPs and crossbars during TDM cycles to reduce one or more of latency, jitter, or symbol drift.

For the method, the time slots may be allocated based on a medium access protocol (MAP) cycle, and the synchronization of the time slots may be performed using an IEEE 1588 protocol.

The method may include buffering input data at the plurality of DSPs during time slot transitions e.g., to prevent data loss and ensure continuous data flow during crossbar reconfiguration.

For the method, the synchronization of the plurality of DSPs and crossbars may be achieved using a common clock signal which may be distributed to one or more of the DSPs by using flow control mechanisms to dynamically adjust timing.

The method may include applying traffic prioritization policies during TDM cycles to allocate higher priority traffic to earlier or more frequent time slots while queuing lower-priority traffic.

The method may include resolving bandwidth contention among multiple DSPs attempting to communicate with the same output port by allocating provisional bandwidth to lower priority requests until contention is resolved.

In some examples, the DSPs may dynamically communicate with the switch controller using out –of-band signaling to request bandwidth allocation, report status, or receive configuration updates.

In some examples, the TDM cycle may use time-division duplexing pipelined across multiple crossbars to enhance resource utilization and reduce reconfiguration delays.

In some examples, the method may include dynamically adjusting the buffer depths in the DSPs based on real-time latency demand and the priority levels of incoming traffic.

In some examples, the switch controller may communicate updated resource allocation MAPs to the DSPs and crossbars during TDM cycles to facilitate real-time updates to routing configurations.

Modifications, additions, or omissions may be made to the method 400 without departing from the scope of the present disclosure. For example, in some examples, the method 400 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 5 illustrates a block diagram of an example communication system 500 configured for time division multiplexing, in accordance with at least one example described in the present disclosure. The communication system 500 may include a digital transmitter 502, a radio frequency circuit 504, a device 512, a digital receiver 506, and a processing device 508. The digital transmitter 502 and the processing device may be configured to receive a baseband signal via connection 510. A transceiver 514 may comprise the digital transmitter 502 and the radio frequency circuit 504.

In some examples, the communication system 500 may include a system of devices that may be configured to communicate with one another via a wired or wireline connection. For example, a wired connection in the communication system 500 may include one or more Ethernet cables, one or more fiber-optic cables, and/or other similar wired communication mediums. Alternatively, or additionally, the communication system 500 may include a system of devices that may be configured to communicate via one or more wireless connections. For example, the communication system 500 may include one or more devices configured to transmit and/or receive radio waves, microwaves, ultrasonic waves, optical waves, electromagnetic induction, and/or similar wireless communications. Alternatively, or additionally, the communication system 500 may include combinations of wireless and/or wired connections. In these and other examples, the communication system 500 may include one or more devices that may be configured to obtain a baseband signal, perform one or more operations to the baseband signal to generate a modified baseband signal, and transmit the modified baseband signal, such as to one or more loads.

In some examples, the communication system 500 may include one or more communication channels that may communicatively couple systems and/or devices included in the communication system 500. For example, the transceiver 514 may be communicatively coupled to the device 512.

In some examples, the transceiver 514 may be configured to obtain a baseband signal. For example, as described herein, the transceiver 514 may be configured to generate a baseband signal and/or receive a baseband signal from another device. In some examples, the

transceiver 514 may be configured to transmit the baseband signal. For example, upon obtaining the baseband signal, the transceiver 514 may be configured to transmit the baseband signal to a separate device, such as the device 512. Alternatively, or additionally, the transceiver 514 may be configured to modify, condition, and/or transform the baseband signal in advance of transmitting the baseband signal. For example, the transceiver 514 may include a quadrature up-converter and/or a digital to analog converter (DAC) that may be configured to modify the baseband signal. Alternatively, or additionally, the transceiver 514 may include a direct radio frequency (RF) sampling converter that may be configured to modify the baseband signal.

In some examples, the digital transmitter 502 may be configured to obtain a baseband signal via connection 510. In some examples, the digital transmitter 502 may be configured to up-convert the baseband signal. For example, the digital transmitter 502 may include a quadrature up-converter to apply to the baseband signal. In some examples, the digital transmitter 502 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 502.

In some examples, the transceiver 514 may include one or more subcomponents that may be used in preparing the baseband signal and/or transmitting the baseband signal. For example, the transceiver 514 may include an RF front end (e.g., in a wireless environment) which may include a power amplifier (PA), a digital transmitter (e.g., 502), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 504) of the transceiver 514 may be synchronized with the resource controller via the S-plane device, which may contribute to high-accuracy timing with respect to a reference clock.

In some examples, the transceiver 514 may be configured to obtain the baseband signal for transmission. For example, the transceiver 514 may receive the baseband signal from a separate device, such as a signal generator. For example, the baseband signal may come from a transducer configured to convert a variable into an electrical signal, such as an audio signal output of a microphone picking up a speaker’s voice. Alternatively, or additionally, the transceiver 514 may be configured to generate a baseband signal for transmission. In these and other examples, the transceiver 514 may be configured to transmit the baseband signal to another device, such as the device 512.

In some examples, the device 512 may be configured to receive a transmission from the transceiver 514. For example, the transceiver 514 may be configured to transmit a baseband signal to the device 512.

In some examples, the radio frequency circuit 504 may be configured to transmit the digital signal received from the digital transmitter 502. In some examples, the radio frequency circuit 504 may be configured to transmit the digital signal to the device 512 and/or the digital receiver 506. In some examples, the digital receiver 506 may be configured to receive a digital signal from the RF circuit and/or send a digital signal to the processing device 508.

In some examples, the processing device 508 may be a standalone device or system, as illustrated. Alternatively, or additionally, the processing device 508 may be a component of another device and/or system. For example, in some examples, the processing device 508 may be included in the transceiver 514. In instances in which the processing device 508 is a standalone device or system, the processing device 508 may be configured to communicate with additional devices and/or systems remote from the processing device 508, such as the transceiver 514 and/or the device 512. For example, the processing device 508 may be configured to send and/or receive transmissions from the transceiver 514 and/or the device 512. In some examples, the processing device 508 may be combined with other elements of the communication system 500.

FIG. 6 illustrates a diagrammatic representation of a machine in the example form of a computing device 600 within which a set of instructions, for causing the machine to perform any one or more of the methods discussed herein, may be executed. The computing device 600 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 600 includes a processing device (e.g., a processor) 602, a main memory 604 (e.g., read-only memory (ROM), flash memory, dynamic random access memory (DRAM) such as synchronous DRAM (SDRAM)), a static memory 606 (e.g., flash memory, static random access memory (SRAM)) and a data storage device 616, which communicate with each other via a bus 608.

Processing device 602 represents one or more general-purpose processing devices such as a microprocessor, central processing unit, or the like. More particularly, the processing device 602 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 may also include one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein.

The computing device 600 may further include a network interface device 622 which may communicate with a network 618. The computing device 600 also may include a display device 610 (e.g., a liquid crystal display (LCD) or a cathode ray tube (CRT)), an alphanumeric input device 612 (e.g., a keyboard), a cursor control device 614 (e.g., a mouse) and a signal generation device 620 (e.g., a speaker). In at least one example, the display device 610, the alphanumeric input device 612, and the cursor control device 614 may be combined into a single component or device (e.g., an LCD touch screen).

The data storage device 616 may include a computer-readable storage medium 624 on which is stored one or more sets of instructions 626 embodying any one or more of the methods or functions described herein. The instructions 626 may also reside, completely or at least partially, within the main memory 604 and/or within the processing device 602 during execution thereof by the computing device 600, the main memory 604 and the processing device 602 also constituting computer-readable media. The instructions may further be transmitted or received over a network 618 via the network interface device 622.

While the computer-readable storage medium 624 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

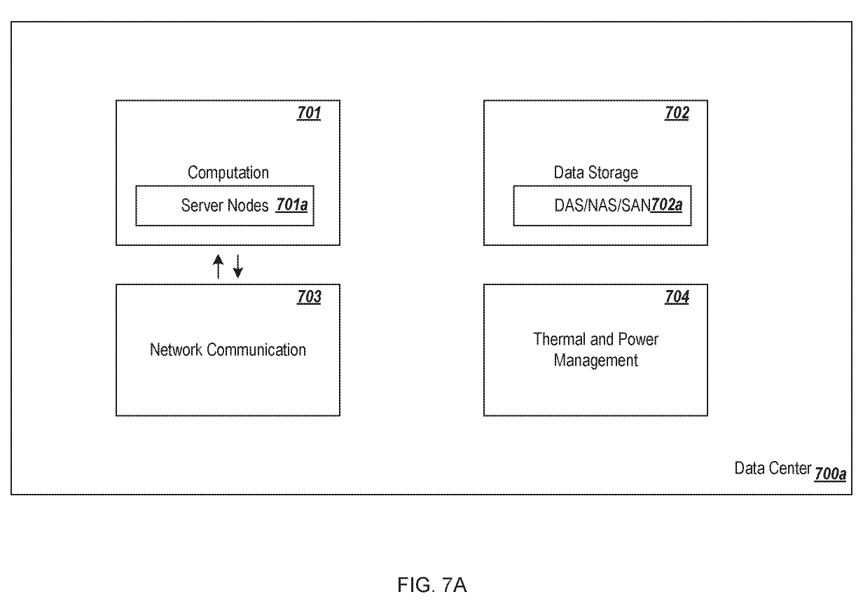

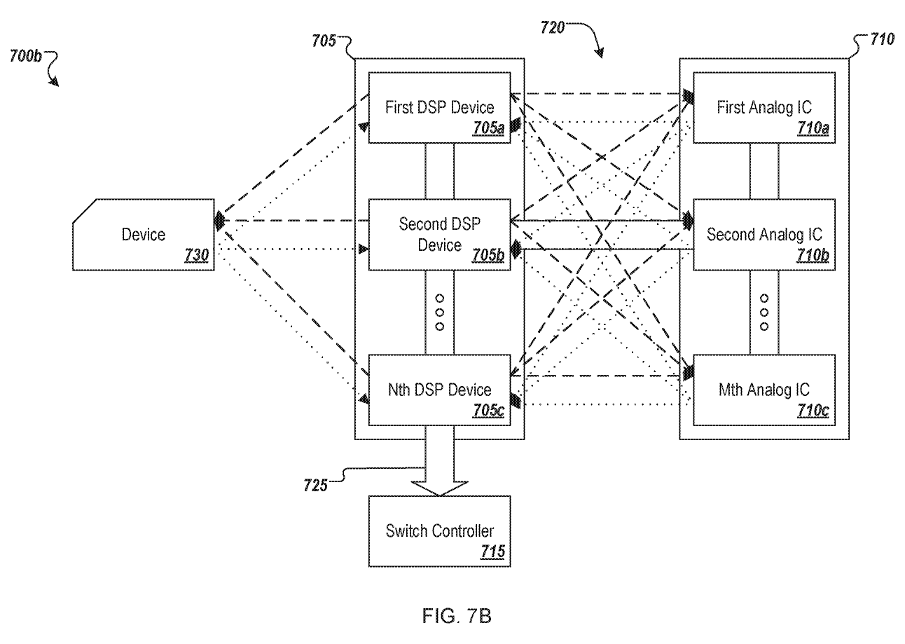

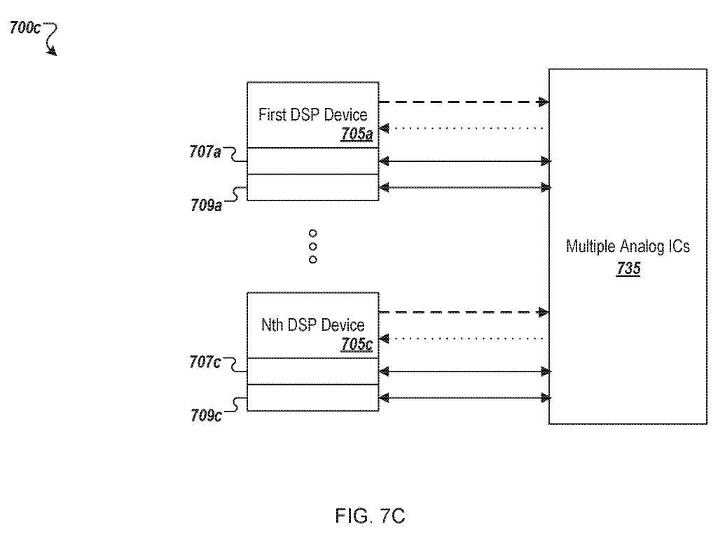

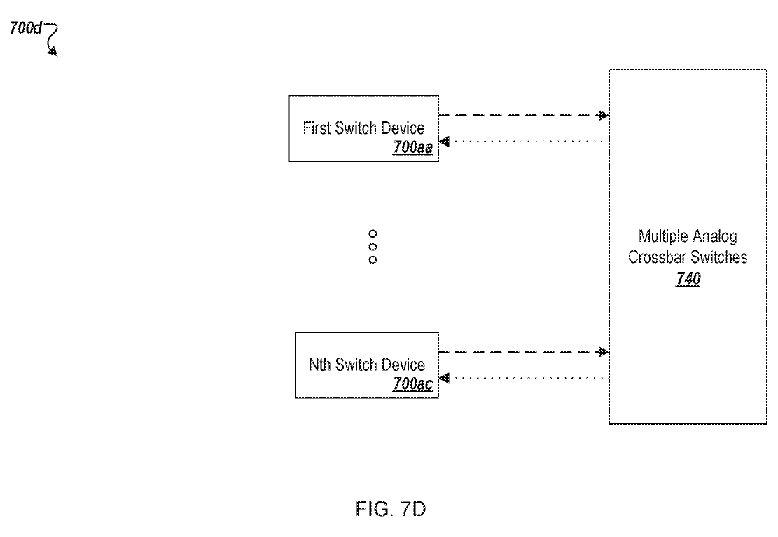

As illustrated in FIG. 7, a block diagram of a data center 700a may include multiple subsystems configured to perform various operational functions, including computation 701, data storage 702, network communication 703, and thermal and power management 704. The computation 701 subsystem may include one or more server nodes 701a that may execute software applications and process data workloads. The data storage 702 subsystem may provide persistent data retention through devices such as hard disk drives, solid-state drives, or distributed storage arrays, which may be organized in configurations such as Direct

Attached Storage (DAS), Network Attached Storage (NAS), or Storage Area Networks (SAN) 702a. The networking communication 703 subsystem may facilitate bidirectional data transfer between servers and external networks through high-speed switching and routing components. The thermal and power management 704 subsystem may maintain operational integrity by regulating temperature and supplying uninterrupted electrical power, e.g., through redundant power sources and cooling mechanisms. Each subsystem may operate in coordination to ensure continuous availability, scalability, and fault tolerance and the ability to scale up and scale out in response to increasing computational and storage demands.

The architecture of a data center 700a may include multiple physical and logical components that collectively enable high-performance computing and data handling. The compute layer may include server racks populated with processors optimized for general-purpose or specialized workloads, including central processing units (CPUs), graphics processing units (GPUs), and field-programmable gate arrays (FPGAs). The storage layer may incorporate hierarchical storage systems that may employ high-speed interfaces such as Non-Volatile Memory Express (NVMe) to reduce latency. The networking layer may use top-of-rack switches, aggregation switches, and core routers arranged in various topologies, (e.g., crossbar, Clos, leaf-spine, etc.) to provide non-blocking connectivity and minimize hop count between endpoints. Power distribution units (PDUs), uninterruptible power supplies (UPS), and backup generators may form the electrical infrastructure, while cooling systems may employ air-based or liquid-based heat dissipation techniques to maintain thermal stability. These components may be integrated to achieve high reliability, modular scalability, and compliance with performance requirements, enabling the system to scale up and scale out as operational loads increase.

In operation, a data center may process client requests through a multi-stage workflow that includes traffic distribution, application execution, and data retrieval. Incoming requests may be received by a load balancing system configured to allocate workloads across multiple compute nodes to prevent resource saturation. Application servers may execute the requested operations, which may involve accessing structured or unstructured data stored within the storage subsystem. Virtualization technologies may enable multiple virtual machines to operate on a single physical server, thereby optimizing resource utilization. Containerization frameworks, such as those implementing Linux containers, may provide isolated execution environments for microservices and facilitate rapid deployment across heterogeneous hardware. The networking subsystem may ensure deterministic packet routing and congestion management through high-speed interconnects and software-defined networking protocols. This operational workflow may be designed to maintain low latency, high throughput, and fault-tolerant performance under variable load conditions, while supporting the ability to scale up and scale out dynamically.

Conventional data center implementations may exhibit several advancements aimed at improving efficiency, scalability, and sustainability. Hyperscale architectures may employ large-scale server clusters interconnected through high-bandwidth fabrics to support cloud computing and artificial intelligence workloads. Edge computing deployments may position micro data centers proximate to end-user devices to reduce network latency and enable real-time processing. Specialized accelerators, including GPUs and tensor processing units (TPUs), may be increasingly integrated to support machine learning and high-performance computing applications. Energy efficiency initiatives may incorporate renewable energy sources and advanced cooling methodologies, such as liquid immersion cooling, to reduce operational costs and environmental impact. These trends reflect an industry-wide transition toward architectures that may be highly distributed, workload-optimized, and environmentally sustainable.

A scale-up network architecture may be characterized by the addition of resources within a single network node or chassis to increase capacity. In such configurations, performance improvements may be achieved by augmenting the processing capability, memory, or port density of an existing switch or router. This approach may involve deploying high-capacity modular switches with vertically integrated backplanes and high-bandwidth switch fabrics. The scale-up model may be advantageous for environments having centralized control and minimal inter-node latency, as all traffic may be processed within a single logical device.

A scale-out network architecture may be characterized by the horizontal expansion of network capacity through the addition of multiple interconnected nodes. In this configuration, performance and scalability may be achieved by distributing workloads across multiple switches, for example arranged as a leaf-spine architecture. Each leaf switch may provide connectivity to compute and storage resources, while spine switches interconnect the leaf layer to form a non-blocking, high-bandwidth fabric. The scale-out model may enable incremental capacity expansion without completely replacing existing infrastructure, thereby supporting elastic growth and fault tolerance. This architecture may be particularly suited for large-scale data centers and cloud environments, where traffic patterns may be highly distributed and use predictable bandwidth. Scale-out networks may leverage parallelism and redundancy to achieve near-linear scalability.

A scale-up network may carry information, including AI training and inference algorithms, among computing units (such as graphics processing units (GPUs)). These networks may have various characteristics such as high bandwidth (e.g., non-blocking all-to-all bandwidth), low latency (e.g., minimize layers of switching and per-switch latency), and scalability (e.g., supporting high numbers of interconnected GPUs and low energy per bit transferred through network). For purposes of this disclosure, a “GPU” has been provided as an example and instances of GPU may be substituted by any type of processor such as CPUs, ASICs, or the like.

Conventional scale-up networks may centralize the switching/routing function in order to scale GPU connectivity across multiple rack units and even multiple racks. An example compute rack may include 18 compute trays consuming about 6kW each, and 9 switch trays consuming about 1kW each. Each GPU may have 18 ports of 100GB/s each (or 1.8TB/s per GPU), and the rack network (which may be implemented using a copper backplane) may connect each GPU to the 9 switch trays to provide each GPU with the ability to deliver all of its 1.8TB/s to any other GPU in the rack, a capability often referred to as “All-to-All bandwidth”. This may be used for parallelizing the computation of an AI model for training or inference purposes.

This rack-level power density may be quite high and push the limit of electrical power and thermal cooling densities, leaving little room for additional compute trays. Furthermore, switch connectivity for all-to-all crossbar-like functionality has complexity and power which may vary quadratically with the number of ports being interconnected, so scaling the GPUs connected within a rack may be constrained, even when the number of GPUs may be increased.

A centralized full crossbar may be replaced with distributed crossbars which places ultra-efficient, ultra-low-latency analog crossbars locally with their respective GPUs, and routes them to digital switch SOCs with an arrangement of crossbars which may be simplified compared with full crossbars. This may drive improvements in network power, latency, complexity, and scalability.

As a result, network traffic (e.g., which may be AI traffic) may be matched with low predictable latency providing all-to-all bandwidth. Compared to Ethernet packet switches, 1/5 of the power may be consumed. The device may be capable of high radix implementations (e.g., 1024 lanes). The device may be usable in all-copper backplane scale ups as well as with multi-mode (MM) fiber.

Thus, the examples described herein present systems and methods for an Analog Electrical Circuit Switch (AECS) switch capable of ultra-low-latency (e.g., <5ns, 10 ns, or the like) and low-power switching across a flexible any-to-any crossbar architecture. The AECS switch eliminates internal buffering and packet inspection within the crossbar, allowing for a highly efficient and scalable architecture. A programmable crossbar configuration may dynamically map input ports to output ports in response to real-time traffic conditions.

An example system may include advanced control mechanisms for broadcasting and multicasting data from a single input to multiple outputs, optimizing resource allocation and minimizing overhead. Make-before-break (MBB) protocols may be employed to ensure seamless reconfiguration of crossbar connections without data loss, even during high-speed operations. Additionally, adaptive equalization techniques may be integrated into the system, allowing the AECS to optimize signal quality based on feedback from connected devices.

An architecture may include redundancies along with digital signal processors (DSPs) configured to support any-to-any connections. In such an arrangement, low-latency switching along with low power use per lane may be achieved. Further, memory included in the DSPs may be used for any storage or buffering and each of the components included in the switch may include redundant lanes such that degradations or broken DSPs may be rerouted around and replaced without losses to the system. The reconfiguration in the switch may be dynamically performed (e.g., such as in view of real-time traffic managed by the switch) by a switch controller that may communicate with the components in the switch using out-of-band traffic so as to not interfere with the in-band communications otherwise being handled by the switch.

FIG. 7B illustrates an example switch device 700b. The switch device 700b may include a first digital signal processor (DSP) device 705a, a second DSP device 705b, an nth DSP device 705c, referred to collectively as multiple first electronic devices 705, a first analog integrated circuit (IC) 710a, a second analog IC 710b, an mth analog IC 710c, referred to collectively as multiple second electronic devices 710, a switch controller 715, in-band traffic 720, and out-of-band traffic 725. First DSP 705a, second DSP 705b, and nth DSP 705c may have input and output as shown in greater detail with respect to FIG. 2.

The switch device 700b may be reconfigurable (e.g., in terms of the connections between the components therein, such as the multiple first electronic devices 705 and the multiple second electronic devices 710, the switch controller 715, and/or a device 730), where the switching of the connections/lanes between the components may be low latency (e.g., less than 5 ns, 10ns, or the like switching). Alternatively, or additionally, the switch device 700b may reconfigure without the use of retiming such that each lane of the multiple lanes included therein may use less than 50 mW of power. For example, each lane of the multiple lanes may support 100G bandwidth while using less than 50 mW of power.

The multiple first electronic devices 705 may individually include one or more ports that may be used to facilitate communications within the switch device 700b, such as between the multiple first electronic devices 705 and the multiple second electronic devices 710, the switch controller 715, and/or a device 730. The communications in the switch device 700b may be transmitted via multiple lanes in the switch device 700b. The multiple lanes may facilitate the in-band traffic 720 and/or the out-of-band traffic 725.

The multiple lanes between the multiple first electronic devices 705 and the multiple second electronic devices 710 may be in an any-to-any configuration. For example, the first DSP device 705a may include a lane to the first analog IC 710a, to the second analog IC 710b, and/or the mth analog IC 710c. A similar arrangement may occur for each of the multiple first electronic devices 705, such that each DSP device of the multiple first electronic devices 705 may include a lane to any number of the multiple second electronic devices 710, including none of the multiple second electronic devices 710. As illustrated in FIG. 7, each lane for facilitating the in-band traffic 720 may be in both directions (e.g., transmit and receive) between the multiple first electronic devices 705, the multiple second electronic devices 710, and/or a device 730. Alternatively, or additionally, the lanes are dashed/dotted to illustrate that for any transmit/receive path between the multiple first electronic devices 705, the multiple second electronic devices 710, and/or a device 730, a lane may or may not be present.

The multiple first electronic devices 705, the multiple second electronic devices 710, and/or the switch controller 715 may be disposed on a printed circuit board (PCB) where traces on the PCB may be used to connect at least the multiple first electronic devices 705, the multiple second electronic devices 710, and/or the switch controller 715 (e.g., the traces on the PCB may facilitate the in-band traffic 720 and/or the out-of-band traffic 725 in the switch device 700b). Alternatively, or additionally, the multiple first electronic devices 705, the multiple second electronic devices 710, and/or the switch controller 715 may be connected to one another using connectors, such as high-speed cables, where the multiple first electronic devices 705, the multiple second electronic devices 710, and/or the switch controller 715 may individually include ports/headers to support the use of the connectors. In instances in which the connectors are used, crosstalk between the multiple lanes in the switch device 700b may be reduced relative to the crosstalk that may occur when the switch device 700b uses traces on a PCB.

The switch device 700b, including the multiple first electronic devices 705, the multiple second electronic devices 710, and/or the switch controller 715, may be utilized with one or more additional switches and/or crossbar devices to form a new crossbar switch device, which may be larger than any one of the switch devices 700b. For example, as illustrated and discussed relative to FIG. 7C, the switch device 700b may be utilized with any other number of switch devices 700b (e.g., the nth switch device 700ac in FIG. 7C) and multiple analog crossbar switches 740 to form a new crossbar switch device.

The multiple first electronic devices 705 may be digital signal processors (DSPs) and/or the multiple second electronic devices 710 may be analog circuit switch integrated circuits (ICs) for use with electrical signals. Alternatively, or additionally the multiple second electronic devices 710 may be analog optical circuit switch ICs for use with optical signals. The multiple first electronic devices 705 may be individually configured to support one or more layer of the open systems interconnection (OSI) model. For example, each of the multiple first electronic devices 705 may be configured to support layer 1 protocols, layer 2 protocols, and/or layer 3 protocols with respect to the in-band traffic 720 and/or the out-of-band traffic 725.

Each, or at least one, of the multiple first electronic devices 705 may support layer 1 protocols, which may include detecting and/or processing layer 2 protocols and/or layer 3 protocols, handling layer 2 protocol and/or layer 3 protocol addressability, frame header detection, packet header inspection, responding to layer 2 protocol and/or layer 3 protocol requests, storing information in response to a request associated with layer 2 protocols and/or layer 3 protocols, updating information in response to a request associated with layer 2 protocols and/or layer 3 protocols, communicating information in response to a request associated with layer 2 protocols and/or layer 3 protocols, optimizing information in response to a request associated with layer 2 protocols and/or layer 3 protocols, etc. Each of the multiple first electronic devices 705 may be able to adjust the way in which traffic is directed through it, such as in response to a command from the switch controller 715. For example, each of the multiple first electronic devices 705 may be operable to configure an internal switch, an external switch, or a crossbar based on the various layer protocol processing to be performed.

The first DSP device 705a may receive a communication that includes a frame header (or a packet header) and the first DSP device 705a may be configured to detect the frame header and decode the frame header along with any associated contents of the communication, all within the first DSP device 705a. In a second example, the first DSP device 705a may integrate a media access control (MAC) address lookup table which may allow the first DSP device 705a to configure one or more crossbars such that the first DSP device 705a may facilitate connectivity between any two MAC addresses that are included in the lookup table. Alternatively, or additionally, each of the first electronic devices 705 may include a lookup table that may store equalization settings that may be used for various connections between the first electronic devices 705 and other components within the switch device 700b. The equalization settings in the lookup table may be used to accelerate acquisition and/or tracking for a particular DSP device of the multiple first electronic devices 705 when the particular DSP device switches connections within the switch device 700b.

The multiple first electronic devices 705 may be configured to respond to layer 2 protocol requests and/or layer 3 protocol requests for connectivity and/or resource grant requests. For example, the multiple first electronic devices 705 may compare a request to a lookup table that includes priority levels and the multiple first electronic devices 705 may be operable to configure themselves and/or associated crossbars and/or switches based on the determined priority level. Alternatively, or additionally, each of the multiple first electronic devices 705 may be configured to respond to in-band requests (e.g., granting a connection request, signaling backpressure to the device 730, etc.), collect statistics on traffic handled by the multiple first electronic devices 705 (e.g., link utilization and/or traffic type), and/or perform data filtering (e.g., detecting a particular header, performing routing, generating flags and/or interrupts, and/or logging any of the filtering events).

The multiple first electronic devices 705 may be configured to communicate with (e.g., transmit data to and/or receive data from) the device 730. The communication with the device 730 may include in-band traffic 720. In such instances, the communications between the multiple first electronic devices 705 and the device 730 may be line-side communications, where the lines may facilitate communications using various communication channels. For example, the line-side communications between the multiple first electronic devices 705 and the device 730 may be an electrical-to-electrical connection, an optical-to-optical connection, an electrical-to-optical connection, or an optical-to-electrical connection, and so forth.

The device 730 may address communications directly to one of the multiple first electronic devices 705. For example, the device 730 may address communications to the second DSP device 705b. Alternatively, or additionally, the device 730 may address communications to the switch controller 715, which may then direct communications to the appropriate DSP device. For example, the device 730 may address communications intended for the second DSP device 705b to the switch controller 715 and the switch controller 715 may direct the communications to the second DSP device 705b.

The multiple first electronic devices 705 may individually include memory that may be used as a buffer for communications through the multiple first electronic devices 705. The memory in the multiple first electronic devices 705 may be utilized to buffer incoming and/or outgoing traffic, which may include in-band traffic 720 and/or out-of-band traffic 725. Due to the memory in the multiple first electronic devices 705 being distributed (e.g., by the distributed nature of the multiple first electronic devices 705), the switch device 700b may not include any memory for buffering in addition to the memory included in the multiple first electronic devices 705.

The multiple first electronic devices 705 may individually include one or more additional lanes that may be used for communications in the switch device 700b. Further details associated with the additional lanes are included in the description associated with FIG. 7C.

The multiple second electronic devices 710 may individually include one or more ports that may be used to facilitate communications within the switch device 700b, similar to the ports described relative to the multiple first electronic devices 705. Alternatively, or additionally, the lanes for communications between the multiple first electronic devices 705 and the multiple second electronic devices 710 may be coupled with the ports included in the multiple second electronic devices 710.

The switch controller 715 may be a microcontroller unit (MCU). Alternatively, or additionally, the switch controller 715 may be a DSP, or other processing device. The switch controller 715 may be communicatively coupled with at least the multiple first electronic devices 705 and/or the multiple second electronic devices 710. The switch controller 715 may resolve resource grant requests, distribute the network state to the multiple first electronic devices 705 and/or to the multiple second electronic device 710, and/or may establish and/or maintain timing among the components included in the switch device 700b.

The switch controller 715 may communicate with the multiple first electronic devices 705 and/or the multiple second electronic devices 710 using a separate connection/lane than the connections between the multiple first electronic devices 705 and the multiple second electronic devices 710. For example, the first connection between the multiple first electronic devices 705 and the multiple second electronic devices 710 may facilitate the in-band traffic 720 and the second connection between the switch controller 715 and the multiple first electronic devices 705 and/or the multiple second electronic devices 710 may facilitate the out-of-band traffic 725.

The out-of-band traffic 725 may use a different network than the in-band traffic 720. Alternatively, or additionally, the out-of-band traffic 725 may use a different physical layer protocol than the in-band traffic 720. The out-of-band traffic 725 may be used to manage and/or configure one or more components included in the switch device 700b. For example, the switch controller 715 may communicate with the multiple first electronic devices 705 using the out-of-band traffic 725 to reconfigure lanes and/or traffic routing based on the traffic through the switch device 700b.

The switch controller 715 may be programmable such that the switch controller 715 may be operable to dynamically map the lanes between the multiple first electronic devices 705 and the multiple second electronic devices 710. For example, in instances in which the first DSP device 705a includes a lane to the first analog IC 710a, the switch controller 715 may dynamically map the lane to be from the first DSP device 705a to the second analog IC 710b. The switch controller 715 may dynamically adapt the mapping of the lanes between the multiple first electronic devices 705 and the multiple second electronic devices 710 based on one or more conditions and/or a satisfaction of a threshold related to the conditions. For example, in instances in which the real-time data traffic in the switch device 700b (or an amount of real-time data traffic handled by one of the multiple first electronic devices 705 and/or one of the multiple second electronic devices 710) satisfies a threshold, the switch controller 715 may dynamically adapt the mapping of the lanes as described.

The switch device 700b may include one or more redundant lanes that may be used in various situations during operation of the switch device 700b. For example, one or more redundant lanes may be used for the out-of-band traffic 725, such as signaling using the out-of-band traffic 725. In such instances, the out-of-band signaling may be transmitted and/or received by a particular DSP device and/or by the switch controller 715, and the out-of-band signaling may be a lower transmission rate than the in-band traffic 720. In another example, one or more redundant lanes may be used for out-of-bandwidth broadcasts from the switch controller 715 and/or from one or more of the multiple first electronic devices 705 to other devices in the switch device 700b (e.g., such as other DSP devices).

The switch controller 715 may reserve a portion of bandwidth associated with the in-band traffic 720 in the switch device 700b. The bandwidth reserved by the switch controller 715 may be reserved on a per lane basis of the multiple lanes included in the switch device 700b. For example, a first lane between the first DSP device 705a and the first analog IC 710a may have a first reserved bandwidth and a second lane between the second DSP device 705b and the second analog IC 710b may have a second reserved bandwidth, where the amount of bandwidth reserved may be the same or may differ between the first reserved bandwidth and the second reserved bandwidth. The switch controller 715 may allocate resources within the switch device 700b based on predicted or anticipated traffic (e.g., based on a probabilistic model).

Alternatively, or additionally, the switch controller 715 may monitor the lanes of the multiple lanes in the switch device 700b. The switch controller 715 may monitor the multiple lanes periodically and/or in a round robin manner, such that the lanes of the multiple lanes may observed to determine if failures or degradations may be present in a lane. In instances in which a lane experiences a degradation that satisfies a threshold for an acceptable loss, the switch controller 715 may dynamically remap a new lane in the switch device 700b to replace the degraded lane.

The switch controller 715 may perform adaptive signal equalization to the in-band traffic 720 in the switch device 700b. For example, the multiple first electronic devices 705 may provide feedback to the switch controller 715 relative to the workload handled by the multiple first electronic devices 705, and the switch controller 715 may adaptively manage workloads of the multiple first electronic devices 705 to optimize performance of the switch device 700b.

A backup switch controller (not illustrated) may be included in the switch device 700b. The backup switch controller may be a redundant controller relative to the switch controller 715. The backup switch controller may include the same or similar connections as the switch controller 715 relative to the multiple first electronic devices 705 and/or the multiple second electronic devices 710. The backup switch controller may perform the same or similar operations as the switch controller 715.

FIG. 7C illustrates an example switch device 700c. The switch device 700c may include a first DSP device 705a, an nth DSP device 705c, and multiple analog ICs 735. The first DSP device 705a may include a first auxiliary channel 707a, and a first out-of-band channel 709a. The nth DSP device 705c may include an nth auxiliary channel 707c, and an nth out-of-band channel 709c.

The first DSP device 705a, the nth DSP device 705c, and the multiple analog ICs 735 may be the same or similar as the first DSP device 705a, the nth DSP device 705c, and the multiple second electronic devices 710, respectively, of FIG. 7A and may be operable to perform the same or similar functions as described.

The auxiliary channels 707 (e.g., the first auxiliary channel 707a and the second auxiliary channel 707c) may be individually utilized by each of the DSP devices 705a, 705c as an additional lane for in-band traffic between at least the DSP devices 705a, 705c and the multiple analog ICs 735. The auxiliary channels 707 may be used to redundantly transmit in-band traffic relative to another lane included in the DSP devices 705a, 705c prior to a change

in configuration to the corresponding DSP devices 705a, 705c. For example, in instances in which the first DSP device 705a includes a lane to a particular analog IC of the multiple analog ICs 735 and the first DSP device 705a is to be reconfigured (e.g., by a switch controller as described herein), the first auxiliary channel 707a may have a lane mapped to the particular analog IC such that the in-band traffic is redundant between the first DSP device 705a and the particular analog IC prior to reconfiguring the lanes associated with the first DSP device 705a (which reconfiguration may otherwise break the connection between the first DSP device 705a and the particular analog IC).

The auxiliary channels 707 may be used for communication between other near DSP devices. For example, in instances in which the first DSP device 705a is disposed spatially near to the nth DSP device 705c, the first DSP device 705a and the nth DSP device 705c may communicate with one another via the auxiliary channels 707. Such communications may be possible as the channels between near-neighbors may be relatively clean, such that physical layer processing may be simplified and may result in power reduction, latency reduction, a lesser amount of equalization, and/or other benefits to the switch device 700c.

The out-of-band channels 709 may be used to communicate the out-of-band traffic (e.g., the out-of-band traffic 725 of FIG. 7B) on a lane separate from the multiple lanes used to communicate in-band traffic. In such instances, the out-of-band channels 709 may not cause blocking or interference to the in-band traffic between at least the DSP devices 705a, 705c and the multiple analog ICs 735.

FIG. 7D illustrates an example aggregated switch device 700d. The aggregated switch device 700d may include a first switch device 700aa, an nth switch device 700ac, and multiple analog crossbar switches 740. The first switch device 700aa and the nth switch device 700ac may individually be the same or similar as the switch device 700b of FIG. 7B.

The aggregated switch device 700d illustrates that any number of the switch devices 700b (e.g., the first switch device 700aa and the nth switch device 700ac) may be aggregated into another switch device and/or connected to other analog crossbar switches. Each of the switch devices 700b may include multiple DSP devices and multiple analog IC and may be further aggregated into the aggregated switch device 700d using the multiple analog crossbar switches 740. As such, the aggregated switch device 700d may be scaled up or down for any size communication need, by adjusting the switch devices 700b and/or the multiple analog crossbar switches 740 to meet the communication demand.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. A device, comprising:
a plurality of digital signal processors (DSPs);
a plurality of analog crossbars operable to be connected to the plurality of DSPs,
wherein the plurality of analog crossbars is operable to:
receive, at one or more input ports of the plurality of analog crossbars, input data from the plurality of DSPs; and
send, from an output port of the plurality of analog crossbars, time-division multiplexed (TDM) output data.

2. The device of claim 1, wherein the TDM output data is allocated using periodic resource allocation.

3. The device of claim 1, wherein the plurality of DSPs is further operable to:
synchronize timing between crossbar switches of the plurality of DSPs to reduce one or more of jitter or symbol drift.

4. The device of claim 1, wherein the plurality of DSPs is further operable to:
reacquire one or more of an equalization setting or a calibration setting during a TDM transition.

5. The device of claim 1, wherein the plurality of DSPs is further operable to:
store a previous configuration of one or more of an equalization setting or a calibration setting in a look-up table (LUT) for faster reacquisition.

6. The device of claim 1, wherein the plurality of DSPs is further operable to:
use make-before break to minimize reacquisition overhead during connection sharing.

7. The device of claim 1, wherein the plurality of DSPs is further operable to:
use make-before break to facilitate time slot transitions.

8. The device of claim 1, wherein the plurality of DSPs is further operable to:
queue data during time slot transitions.

9. The device of claim 1, wherein the plurality of DSPs is further operable to:
use one or more of flow control or internet protocol (IP) termination to enhance TDM efficiency.

10. The device of claim 1, wherein the plurality of DSPs is further operable to:
synchronize timing between the plurality of DSPs using a common clock source.

11. A method for time-division multiplexing (TDM) in a network architecture incorporating an analog electrical circuit switch (AECS), comprising:
receiving, at one or more input ports of a plurality of analog crossbars, input data from a plurality of digital signal processors (DSPs);
determining time slots dynamically to the plurality of DSPs based on one or more of real-time bandwidth, traffic priority levels, or network conditions;
configuring, at a switch controller, the plurality of analog crossbars to facilitate sharing of output ports by the plurality of DSPs during allocated time slots;
synchronizing the time slots across the plurality of DSPs and analog crossbars using one or more of a common time base or synchronization protocol;
transmitting, from one or more output ports of the plurality of analog crossbars, time-division multiplexed output data comprising data from multiple input ports; and
maintaining synchronization of the plurality of DSPs and crossbars during TDM cycles to reduce one or more of latency, jitter, or symbol drift.

12. The method of claim 11, wherein the time slots are allocated based on a medium access protocol (MAP) cycle, and the synchronization of the time slots is performed using an IEEE 1588 protocol.

13. The method of claim 11, further comprising buffering input data at the plurality of DSPs during time slot transitions.

14. The method of claim 11, wherein the configuring of the analog crossbars includes dynamically adjusting crossbar switch configurations based on packet inspection performed at one or more of Layer 2 (L2) or Layer 3 (L3) of the DSPs.

15. The method of claim 11, wherein the synchronization of the plurality of DSPs and crossbars is achieved using a common clock signal.

16. The method of claim 11, further comprising implementing a make-before-break (MBB) transition to reduce reacquisition overhead during time slot transitions.

17. The method of claim 11, wherein the reacquisition techniques include referencing stored equalization settings, clock recovery parameters, or lookup table (LUT) entries to minimize reacquisition latency.

18. The method of claim 11, further comprising applying traffic prioritization policies during TDM cycles to allocate higher-priority traffic to earlier or more frequent time slots.

19. The method of claim 11, wherein the time-division multiplexed output data is transmitted over optical communication channels, and the analog crossbars are optical circuit switches.

20. The method of claim 11, further comprising implementing virtual output queuing at the output ports of the analog crossbars to enhance resource sharing and prevent contention among input data streams.
